(19) United States
(12) Patent Application Publication
(10) Pub. No.: US 2022/0185683 A1
(43) Pub. Date: Jun. 16, 2022

(54) Methods for Producing Seed for Growth of Hollow Spheres

(71) Applicant: Plassein Technologies Ltd. LLC, Las Vegas, NV (US)

(72) Inventor: David Charles Lynch, Kingsport, TN (US)

(21) Appl. No.: 17/530,963

(22) Filed: Nov. 19, 2021

Related U.S. Application Data
(60) Provisional application No. 63/116,057, filed on Nov. 19, 2020.

(51) Int. Cl. C01B 33/18; B01J 13/04; B01J 13/20; C03B 19/10

(52) U.S. Cl. CPC C01B 33/181; B01J 13/04; C01P 2004/34; C03B 19/107; B01J 13/203

(57) ABSTRACT

Methods and apparatus are disclosed for producing seeds that are transformed into hollow spheres. A seed includes a core and a coating. Upon heating, the coating becomes viscous and expands responsive to an internal gas pressure created by the core. Example applications for the seeds and/or cores are disclosed, including bricks and other construction materials having the hollow spheres incorporated therein.

### RELATED APPLICATIONS

This application claims the benefit of priority of U.S. Provisional Patent Application No. 63/116,057, filed on Nov. 19, 2020 by the same inventor, which is incorporated herein by reference in its entirety.

### BACKGROUND OF THE INVENTION

### Field of the Invention

This invention relates generally to the production of hollow spheres, and more particularly to methods for producing seeds that can be transformed into hollow spheres.

### Description of the Background Art

Hollow spheres, known as Cenospheres, are a byproduct from coal fired power plants. Cenospheres are collected from fly ash. The composition of a Cenosphere is a function of the coal composition burned; there is no preparing of materials to achieve Cenospheres with specific properties.

Methods for synthesizing hollow silica spheres have been a topic of research since 1968, gaining greater interest as the field of nanomaterials has advanced. In known methods for the synthesizing of hollow spheres, a preform is created and silica is deposited around the form by chemical processes. The interior preform is removed by either chemical reaction or firing at temperatures up to 500° C. The latter technique has proved more successful in retaining the hollow spherical shape. Scanning electron microscopy reveals that the wall structure of the hollow spheres consists of smaller spheres of silica. The micrographs reveal that the wall of a sphere formed by such synthesis is porous.

### SUMMARY

The present invention overcomes the problems associated with the prior art by providing systems and methods for producing seeds, which can be transformed into hollow spheres.

The present invention discloses methods for producing a chemical construct including a core and a coating surrounding the core, the construct forming a hollow structure upon heating. In this document the construct is referred to as a seed. Upon heating, the coating's viscosity decreases, while the core produces, on its own or through interaction with the coating, a gas that causes the coating to expand forming a hollow sphere. In this document that process is referred to as the transformation of a seed to a hollow sphere.

The core can be a compound, or element, or any combination of compounds, or combination of any elements, or any combination of both compounds and elements that possess the requisite properties to provide the functionality (e.g., gas formation, etc.) described herein. The core produces a gas by chemical reaction between compounds, or between compounds and elements, between elements, between any combination of compounds and elements, and by compound decomposition. Any of the core materials may react with the coating to produce a gas.

The coating material exists as a viscous fluid or forms a viscous fluid upon heating. The coating can be either fused silica, or glass, or silica frit, or glass frit, or quartz crystals, or any mixture of compounds, or mixture of elements, or a combination of compounds and elements that possess the requisite physical properties, including a temperature dependent viscosity within a desired range for a particular application.

An example method for producing a seed capable of transformation into a hollow structure is disclosed. The method includes providing a core and forming a coating around the core. The core is selected to be of a particular composition that when heated reacts to generate a gas. The coating is selected to have a particular composition that when heated will fuse to form a continuous shell surrounding the core and trapping the gas generated by the core within the shell. The trapped gas will produce a temperature dependent pressure within the shell. The particular composition of the coating has a temperature dependent viscosity. A first temperature corresponds to a working point of the particular composition of the coating, and a second temperature corresponds to a fluid point of the particular composition of the coating, a temperature at which the viscosity of the coating is too low to form a hollow structure. A third temperature corresponds to an equilibrium point, where the pressure generated by the trapped gas within the shell is equal to a pressure outside of the shell. The particular composition of the core and the particular composition of the coating are selected so that the third temperature is greater than or equal to the first temperature, and the third temperature is less than the second temperature.

Optionally, the pressure generated by the gas at the equilibrium point can be one atmosphere. As another option, the particular composition of the core and the particular composition of the coating can be selected so that third temperature is equal to the first temperature.

In example methods, the step of forming the coating around the core can include oxidizing a surface of the core to produce an oxidized core. The step of forming the coating around the core can include heating the core in the presence of an oxidizing gas. Heating the core in the presence of the oxidizing gas can include heating the core with a laser, with microwaves, or with any other suitable means.

An example method can additionally include heating the oxidized core to a temperature sufficient to adhere SiO₂ particulate to the oxidized core, and mixing the heated oxidized core with SiO₂ particulate to produce a coated core. The example method can additionally include re-heating the coated core to a temperature sufficient to adhere additional SiO₂ particulate to the coated core, and mixing the re-heated coated core with SiO₂ particulate to produce a thicker coating of SiO₂ on the coated core.

Another example method can additionally include heating the oxidized core to a temperature sufficient to adhere particulate glass frit to the oxidized core, and mixing the heated oxidized core with particulate glass frit to produce a coated core. The example method can additionally include re-heating the coated core to a temperature sufficient to adhere additional particulate glass frit to the coated core, and mixing the re-heated coated core with particulate glass frit to produce a thicker coating of glass frit on the coated core.

Another example method can additionally include heating the oxidized core to a temperature sufficient to adhere particulate of an admixture to the oxidized core, and mixing the heated oxidized core with particulate of an admixture to produce a coated core. The example method can additionally include re-heating the coated core to a temperature sufficient to adhere additional particulate admixture to the coated core, and mixing the re-heated coated core with particulate admixture to produce a thicker coating of admixture on the coated core.

In an example method, the step of forming the coating around the core can include placing a fine powder of the particular composition of the coating on a conveyor. The conveyor can be operative to move the fine powder along a first direction. The example method additionally includes heating spots of the fine powder to a temperature sufficient to cause the particles of the fine powder to stick together, and depositing particulate of the particular composition of the core at the center of the heated spots. The particulate size of the particulate of the particular composition of the core can be larger than the particulate size of the fine powder. In example methods, the particular composition of the core can include at least one of silicon carbide, silicon, calcium carbonate, and a mixture of carbon and magnetite. The example method additionally includes depositing an additional quantity of the fine powder of the particular composition of the coating over the deposited particulate of the particular composition of the core, and reheating the spots with the particulate of the composition of the core and the additional quantity of the fine powder deposited thereover to form the coating around the core.

Optionally, the heating of the spots can be accomplished with one or more lasers. In a more particular example method, the heating of the spots can be accomplished with a linear array of lasers disposed over the conveyor and oriented transversely with respect to the first direction (e.g., transverse to the direction of conveyance).

In another example method, the step of depositing particulate of the particular composition of the core can be accomplished with a linear array of printer nozzles disposed over the conveyor and oriented transversely with respect to the first direction.

Different example methods will produce seeds wherein in the coating around the core is porous or non-porous, depending on the method selected.

Example methods additionally include physically separating the core with the coating from the fine powder used to create the coating. Optionally, the separated cores can be reheated to at least partially bond the coating to the core or form a cage around the core.

In example methods, the particular composition of the core can include at least one of silicon carbide, silicon, calcium carbonate, and a mixture of carbon and magnetite.

In other example methods, the step of forming the coating around the core can include providing a mixture including particulate of the particular composition of the core and a powder of the particular composition of the coating. The mixture can then be placed in a container and irradiated with microwaves to form the seeds. The container can be a fused silica container. The example method can also include applying a release agent to an interior of the container prior to placing the mixture in the container. The release agent can include, by way of non-limiting example, a powder of silica.

In example methods, the container can be at least partially transparent to the microwaves. The particulate of the composition of the core can absorb the microwaves, and the powder of the particular composition of the coating can be at least partially transparent to the microwaves. The mixture can irradiated with the microwaves in an oxidizing atmosphere or in an inert atmosphere. The step of irradiating the mixture with microwaves can include irradiating the mixture with microwaves from one, two, or more different directions.

In a particular example method, the steps of providing the mixture and placing the mixture in the container can include placing alternating layers of the powder of the particular composition of the coating and the particulate of the particular composition of the core in the container.

Example methods for producing an article of manufacture having hollow spheres embedded therein are also disclosed. Example methods include providing a base material that, when heated to a particular manufacturing temperature, transforms into a finished material. The example methods additionally include providing seeds that when heated transform into hollow spheres. The seeds are mixed with the base material to form a mixture of the seeds and the base material. The example methods additionally include heating the mixture to the manufacturing temperature to form a composite of the finished material with the hollow spheres embedded therein.

The seeds each include a core and a coating around the core. The core can have a particular composition that when heated reacts to form a gas. The coating can have a particular composition that when heated will fuse to form a continuous shell surrounding the core and trapping the gas generated by the core within the shell. The trapped gas can produce a temperature dependent pressure within the shell, and the particular composition of the coating has a temperature dependent viscosity. A first temperature corresponds to a working point of the particular composition of the coating, and a second temperature corresponds to a fluid point of the particular composition of the coating, where the viscosity is too low to form a hollow structure. A third temperature corresponds to an equilibrium point where the pressure generated by the trapped gas within the shell is equal to a pressure outside of the shell. The particular composition of the core and the particular composition of the coating are selected so that the third temperature is greater than or equal to the first temperature, the third temperature is less than the second temperature, the manufacturing temperature is greater than or equal to the first temperature, and the manufacturing temperature is less than the second temperature.

The article of manufacture can be a ceramic, a brick or other masonry product, or any other product that requires or can withstand a heat process within a temperature range suitable to transform the embedded seeds to hollow spheres. This list of example applications is not to be considered as limiting.

### BRIEF DESCRIPTION OF THE DRAWINGS

The present invention is described with reference to the following drawings, wherein like reference numbers denote substantially similar elements:

FIG. 1 illustrates the transformation of a seed to a hollow sphere;

FIG. 2 is a graph showing the relationship between viscosity of a coating in a seed and the vapor pressure of a chemical reaction that expands the coating;

FIG. 3 is a graph showing the impact of selecting an alternative coating material of conditions for growth of a hollow sphere;

FIG. 4 is a graph showing the impact of changing the composition of the core on operational temperature for producing hollow spheres;

FIG. 5 illustrates an example apparatus for converting individual seeds to hollow spheres using a plasma torch;

FIG. 6 illustrates how the confined expansion of seeds to hollow spheres can distort the shape of the hollow sphere as well as produce a bulk form with little or no voids between expanded cells;

FIG. 7 illustrates a method for converting seeds to hollow spheres, while forming layered sheets of hollow spheres;

FIG. 8 is a graph that shows properties of bricks as they undergo a firing process;

FIG. 9A summarizes a method for including hollow spheres in forming bricks;

FIG. 9B summarizes another method for including hollow spheres in forming bricks;

FIG. 9C summarizes another method for including hollow spheres in forming bricks;

FIG. 9D summarizes another method for including hollow spheres in forming bricks;

FIG. 9E summarizes another method for including hollow spheres in forming bricks;

FIG. 10 illustrates the transformation of seeds to hollow structures within a brick;

FIG. 11 illustrates the shrinkage of hollow structures within a brick and the blocking of pores within the brick;

FIG. 12 illustrates damage to a brick structure caused by the wet-freeze-thaw cycle; and

FIG. 13 illustrates the use of a release agent and the expansion of a hollow structure to form a locking mechanism.

### DETAILED DESCRIPTION

The present invention overcomes the problems associated with the prior art, by providing methods for producing seeds which can be transformed into hollow spheres, and by providing useful applications for the seeds and spheres. In the following description, numerous specific details are set forth (e.g., core compositions, coating compositions, graphs relating properties of particular core and coating compositions, and so on) in order to provide a thorough understanding of the invention. Those skilled in the art will recognize, however, that the invention may be practiced apart from these specific details. In other instances, details of well-known chemical engineering practices (e.g., controlling pressure, controlling temperature, controlling reactor environments, and so on) and equipment have been omitted, so as not to unnecessarily obscure the present invention.

The following definitions are provided to facilitate a clear explanation of example structures and processes. These definitions are not intended to limit the scope of the present invention, which is defined only by the claims of this application and/or the claims any related continuing applications.
atm—abbreviation for atmosphere.
coating—The coating is the material surrounding the core of a seed. Initially the coating can be crystalline or a viscous fluid. Upon heating the coating, if initially crystalline, transforms into a viscous fluid.
conversion—word used to represent the process of seed transformed into a hollow sphere.
core—The core is that portion of a seed that upon heating generates a gas on its own or through reaction with the coating.
frit—Frit is used to represent both powdered glass, and powdered admixture of compounds and/or elements that form glass upon heating.
HGMS—Hollow Glass Microspheres, which can be spherical or non-spherical in shape.
HGS—Hollow Glass Spheres, which can be spherical or non-spherical in shape.
hollow sphere—refers to hollow structures of any shape including spherical and non-spherical.
HSMS—Hollow Silica Microspheres, which can be spherical or non-spherical in shape.
HSS—Hollow Silica Spheres, which can be spherical or non-spherical in shape.
light—Includes light from a laser, which can be visible or invisible, as well as any other electromagnetic signal of any wavelength from any source.
M—abbreviation for metal.
MO—abbreviation for metal oxide of any stoichiometry.
M₂Si and MSi—abbreviation for metal silicide of any stoichiometry.
seed—a physical construct consisting of a coated core that upon heating can form a hollow sphere.
silica—silica is used to represent both fused silica and crystalline silica.
transform/transformation—the physical process a seed undergoes upon heating in producing a hollow structure or sphere.

Methods, seeds, and hollow spheres are disclosed by the inventor in prior filed U.S. Patent Applications. For example, U.S. patent application Ser. No. 15/399,592 (the '592 application) discloses methods for producing hollow silica microspheres (HSMS). U.S. patent application Ser. No. 17/002,645 discloses methods of using the hollow silica microspheres of the '592 application to producing ceramic hollow spheres. U.S. patent application Ser. No. 17/468,138 discloses methods for producing hollow glass and hollow silica spheres. All of these prior applications are incorporated herein by reference in their respective entireties. The constructs (e.g., seeds, cores, coatings, etc.) and methods of the present application may be advantageously used in combination with the disclosures of the prior applications.

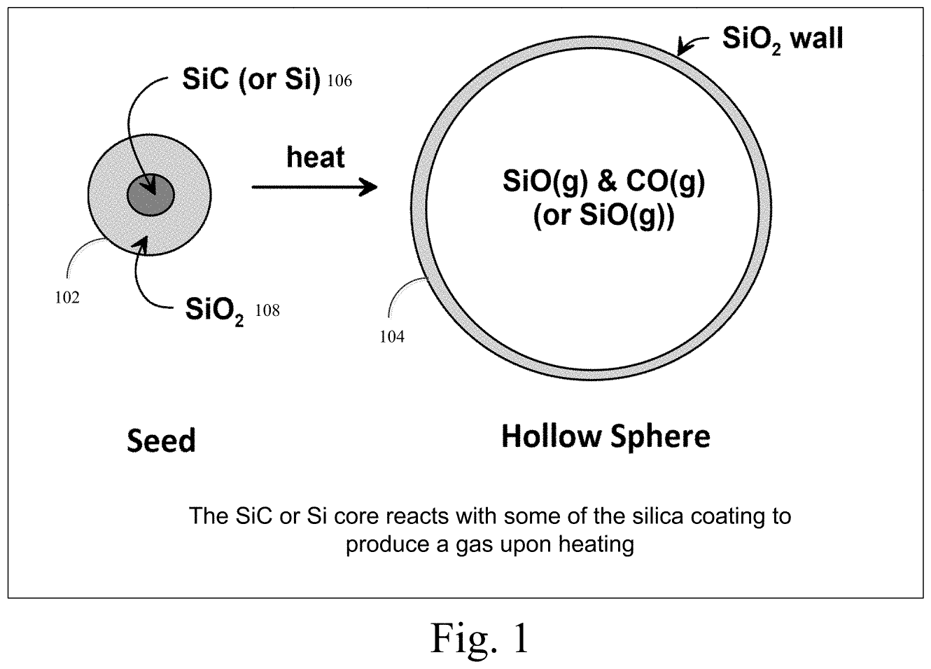

FIG. 1 shows a seed 102 being transformed to a hollow sphere 104. A silicon carbide (SiC) core 106 or a silicon (Si) core 106 is coated with a silica (SiO₂) coating 108 prior to heating, as represented by the left side of the drawing in FIG. 1. The seed is constructed to produce a gas through a chemical reaction. That is, the composition of the seed and/or core is/are selected to produce the gas within an expandable shell when heated. The gas generated by the reaction expands the coating, provided the coating has fused and its viscosity is low enough to allow it to respond to the increasing pressure inside the hollow sphere as the gas is formed. While the core and seed are represented as being spherical in FIG. 1, it should be understood that they can be of any shape. Furthermore, the conversion process may produce hollow spheres or any other hollow structures having different shapes.

During transformation, the core transforms into a gas, either by reactions within the core, or by reactions between the core and the coating. After expansion and during cooling, the gas reverts to a solid (e.g., a dust, small particulates, etc.). However, due to the expanded volume of the hollow sphere, the pressure within the sphere will be extremely low, on the order of 10⁻⁸ atmospheres.

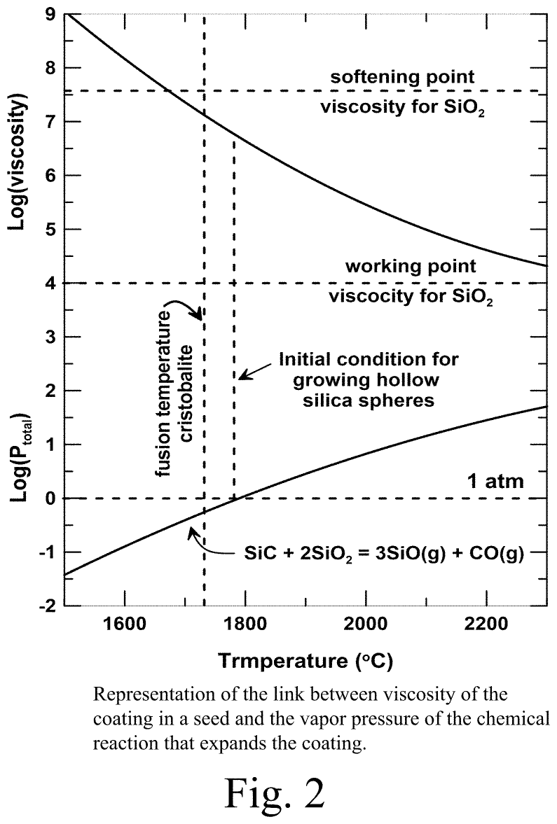

FIG. 2 is a graph that illustrates, for a SiC—SiO₂ seed, the temperature link between the chemical thermodynamics for producing gas (that will form the hollow sphere) and the viscosity of the coating (that must flow for expansion of the hollow sphere). Expansion can occur when the viscosity of the coating is at its softening point, but growth would be very slow. It is desirable, but not required, for the viscosity of the coating to be between its flow point and working point values. The “flow point” is the temperature corresponding to the viscosity of 5 Log₁₀ Poise. At this point glass begins to flow freely if unrestrained, and the “working point” is the temperature corresponding to the viscosity of 4 Log₁₀ Poise. At this point the glass is sufficiently soft for the shaping (blowing, pressing) in a glass forming process.

The selection of the value for the viscosity sets the temperature for converting a seed to a hollow sphere, and that temperature dictates the internal pressure at the interface between core and coating. The internal pressure of the seed and the viscosity of its coating sets the limit on the pressure differential across the fused coating. A higher viscosity requires a lower differential pressure, whereas a higher differential pressure is possible with a lower viscosity. Too high a viscosity and pressure differential can rupture the seed's coating, and too low a viscosity and pressure differential can lead to the coating forming droplets and exposing the core to the surrounding atmosphere.

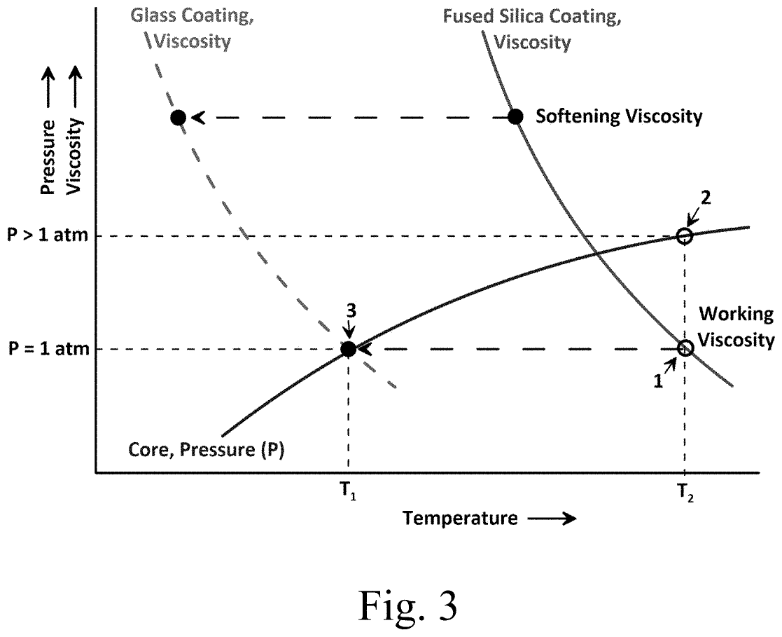

FIG. 3 is a graph that illustrates how the conversion of a seed at an external pressure of 1 atmosphere can be achieved by altering the viscosity curve of the coating to lower temperatures. In FIG. 3, the viscosity of the coating and the pressure of the gas created in the core of the seed are plotted on the same y-axis as a function of temperature. Lines for viscosity are labeled according to the composition of the coating, and the curve representing the total gas pressure for one chemical reaction, as computed through use of chemical thermodynamics, is labeled as the core pressure (P). For a coating of silica, and assuming that it is desirable to convert a seed to a hollow sphere when the viscosity of the coating is that at the working point temperature, point 1, the internal pressure is substantially greater than 1 atm as represented by point 2. Controlled growth of a hollow sphere requires operating a reactor at a pressure slightly less than that associated with point 2, or by raising the temperature above T₂ while maintaining the external pressure at point 2. Selecting a glass as the coating material shifts the viscosity curve to the left, as represented by the line for the viscosity of the glass coating. A glass composition can be selected that matches the working point temperature with the line for the equilibrium pressure for the chemical reaction occurring in the core at 1 atm, i.e., point 3 in FIG. 3. Conditions at point 3 eliminate any need to pressurize a reactor. By raising the temperature above T₁, growth of the hollow sphere is achieved.

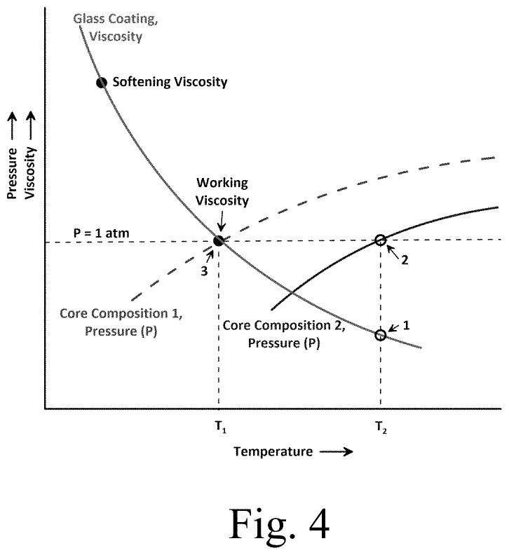

FIG. 4 demonstrates what can be achieved by altering the composition of the core that generates the gas that transforms the seed into a hollow sphere. Core composition 2 at temperature T₂ generates a gas in the core with an equilibrium pressure of 1 atm at point 2, as shown in FIG. 4. At T₂ the viscosity of the glass coating the core (point 1) is significantly lower than that at the working point. The highly fluid glass forms droplets that fall away from the seed, thinning the coating to the point of exposing the core to ambient conditions. That exposure brings any growth of a hollow sphere to a stop. By altering the composition of the core, the pressure curve can be moved to the left, as shown by the curve for core composition 1 in FIG. 4. Doing so facilitates an equilibrium gas pressure at 1 atm, while the coating has a viscosity between that of the Fluid Point and the Working Point values as occurs at point 3 at T₁.

Combing the modifications illustrated in FIGS. 3 and 4 informs the selection of materials that can achieve a significant reduction in the temperature needed to produce HGS. HGS, however, have a lower maximum service temperature than HSS. There are, therefore, applications where HGS cannot substitute for HSS.

Core Chemistry:

Examples of core and coating compositions of seeds, and the resulting reactions are presented below. The list is not to be considered limiting, but representative of a class of reactions.

(a) Seed Composition I
Core: SiC or SiC plus carbon
Coating: SiO₂

SiC+2SiO₂→3SiO(g)+CO(g) Primary Chemical Reaction
Comment: SiC reacts with SiO₂ in the coating

(b) Seed Composition II
Core: Si or Si plus carbon
Coating: SiO₂

Si+SiO₂→2SiO(g) Primary Chemical Reaction
Comment: Si reacts with SiO₂ in the coating

(c) Seed Composition III
Core: SiC & SiO₂ or SiC & SiO₂ plus carbon
Coating: SiO₂

SiC+2SiO₂→3SiO(g)+CO(g) Primary Chemical Reaction
Comment: SiC—SiO₂ core mixture limits chemical reaction with coating

(d) Seed Composition IV
Core: Si & SiO₂ or Si & SiO₂ plus carbon
Coating: SiO₂

Si+SiO₂→2SiO(g) Primary Chemical Reaction
Comment: Si—SiO₂ core mixture limits chemical reaction with coating

(e) Seed Composition V
Core: SiC or SiC plus carbon
Coating: Glass Frit

SiC+2SiO₂→3SiO(g)+CO(g) Primary Chemical Reaction
Comment: SiC reacts with SiO₂ in the glass frit coating

(f) Seed Composition VI
Core: Si or Si plus carbon
Coating: Glass Frit

Si+SiO₂→2SiO(g) Primary Chemical Reaction
Comment: Si reacts with SiO₂ in the glass frit coating

(g) Seed Composition VII
Core: SiC & SiO₂ or SiC & SiO₂ plus carbon
Coating: Glass Frit

SiC+2SiO₂→3SiO(g)+CO(g) Primary Chemical Reaction
Comment: SiC—SiO₂ core mixture limits chemical reaction with coating

(h) Seed Composition VIII
Core: Si & SiO₂ or Si & SiO₂ plus carbon
Coating: Glass Frit

Si+SiO₂→2SiO(g) Primary Chemical Reaction
Comment: Si—SiO₂ core mixture limits chemical reaction with coating

(i) Seed Composition IX
Core: CaCO₃ or CaCO₃ plus carbon
Coating: Glass Frit

CaCO₃→CaO+CO₂(g)

CO₂(g)+C→2CO(g) Primary Chemical Reaction
Comment: CaO and some CO₂ can dissolve in the glass coating

(j) Seed Composition X
Core: Fe₃O₄ & C
Coating: Glass Frit

2.404Fe₃O₄+C→7.614Fe_{0.947}O+CO₂(g), and

CO₂(g)+C→2CO(g) Primary Chemical Reaction
Comment: Fe_{0.947}O and some CO₂ can dissolve in the glass coating

(k) Seed Composition XI
Core: M & MO plus carbon
Coating: Glass Frit or SiO₂

MO+C→CO(g)+M or

2MO+C→CO₂(g)+2M Primary Chemical Reaction
Comment: Some CO₂, CO, and MO can dissolve in the coating

(l) Seed Composition XII
Core: SiC & MO or SiC & MO plus carbon
Coating: Glass Frit or Silica

SiC+2MO→CO₂(g)+M₂Si, or

SiC+MO→CO(g)+MSi Primary Chemical Reaction
Comment: M₂Si and MSi represent any metal silicide

Systems and methods for the formation of seeds are disclosed herein. The disclosed methods involve, by way of non-limiting example, the core chemistries set forth above. However, it should be understood that the methods can be modified to include any core and/or coating materials/chemistry that will produce a suitable balance between the viscosity of the coating and the gas pressure produced by the core at/within a predetermined temperature range.

Methods and compositions are presented herein for forming seeds that can be converted to hollow spheres without a preform, or removal of a preform. Methods for producing seeds for generating hollow spheres for specific application are also disclosed. The ability to meet specific requirements begins with the composition of the seed.

By forming seeds for conversion to hollow spheres, a seed can be included in a substance and converted to a hollow sphere during firing of the raw material, as in the firing of ceramics to improve strength at lower temperatures. A seed can also be converted to a hollow sphere separately, and used as a template for forming hollow spheres from other materials, as in producing light weight composites with hollow ceramic spheres in highly reactive metals such as aluminum and magnesium. A seed can also be converted separately to a hollow sphere for use with other material as an additive in, for example, drywall, fiber cement, and concrete to reduce weight, increase resistance to heat transfer, and reduce sound transmission. A seed can also be converted to a hollow sphere separately, but with additions to the seeds, for use with other material, as in paint or with compounds to scatter electromagnetic signal, absorb unwanted ultraviolet light, and/or to kill pathogens. A seed can also be converted to a hollow sphere in a mold with other seeds to produce a honeycomb structure that provides an alternative to conventional drywall, glass bricks, and siding for structures. A seed can also be used artistically in a new approach for producing stained glass. A seed can also be converted to a hollow sphere extra-terrestrially to reflect sun light to combat global warming. These are only some of the potential applications for seeds that can be converted to hollow spheres.

Specific example methods for producing seeds that can be converted to hollow spheres are presented below. While specific examples are presented, those examples are not to be considered as being limiting, but as representative of processes for general classes of systems where a core, on its own or in contact with its coating, produces a gas that can expand the vitreous coating that surrounds the core.

One group of production methods includes the partial oxidation of a core to produce a seed (e.g., a core plus a coating). For example, a seed with a SiC core and an SiO₂ coating can be formed by partially oxidizing an SiC particle.

In a first example seed production method, silicon carbide particles exposed to a hot oxidizing gas will form an oxidized layer of SiO₂. As the thickness of the oxide layer increases the rate of oxidation declines. At high temperatures the SiO₂ forms a protective layer, isolating the core from the external environment.

In a second example seed production method, silicon carbide particles exposed to a microwave field in an oxidizing gas will form an oxidized layer of SiO₂. The microwaves heat the SiC particle that, in turn, heats the oxidizing gas near the particle. As the thickness of the oxide layer increases the rate of oxidation declines. At high temperatures the SiO₂ forms a protective layer, isolating the core from the external environment.

In a third example seed production method, silicon carbide particles exposed to the light from a laser in an oxidizing gas will form an oxidized layer of SiO₂. The light from the laser heats the SiC particle that, in turn, heats the oxidizing gas near the particle. As the thickness of the oxide layer increases the rate of oxidation declines. At high temperatures the SiO₂ forms a protective layer, isolating the core from the external environment.

In a fourth example seed production method, silicon carbide particles are heated by any combinations of methods presented in the first three example methods in an oxidizing gas forming an oxidized layer of SiO₂. As the thickness of the oxide layer increases the rate of oxidation declines. At high temperatures the SiO₂ forms a protective layer, isolating the core from the external environment.

As another example, in the first group of production methods, a seed with a Si core and an SiO₂ coating can be formed by partially oxidizing an Si particle.

In a fifth example production method, silicon particles exposed to a hot oxidizing gas will form an oxidized layer of SiO₂. As the thickness of the oxide layer increases the rate of oxidation declines. At high temperatures the SiO₂ forms a protective layer, isolating the core from the external environment.

In a sixth example seed production method, silicon particles exposed to a microwave field in an oxidizing gas will form an oxidized layer of SiO₂. The microwaves heat the Si particle that, in turn, heats the oxidizing gas near the particle. As the thickness of the oxide layer increases the rate of oxidation declines. At high temperatures the SiO₂ forms a protective layer, isolating the core from the composition of the external environment.

In a seventh example seed production method, silicon particles exposed to the light from a laser in an oxidizing gas will form an oxidized layer of SiO₂. The light from the laser heats the Si particle that, in turn, heats the oxidizing gas near the particle. As the thickness of the oxide layer increases the rate of oxidation declines. At high temperatures the SiO₂ forms a protective layer, isolating the core from the external environment.

In an eighth example seed production method, silicon particles are heated by any combination of the methods presented in the fifth, sixth, and seventh example productions methods in an oxidizing gas forming an oxidized layer of SiO₂. As the thickness of the oxide layer increases the rate of oxidation declines. At high temperatures the SiO₂ forms a protective layer, isolating the core from the external environment.

In a second group of seed production methods, an additional coating is applied to partially oxidized cores to produce seed. The partially oxidized cores can be produced using the methods of the first group described above, and then the additional coating can be applied using one of the production methods of the second group.

For example, in a ninth example seed production method, hot partially oxidized Si or SiC cores are charged separated (not in clumps) or in clumps to a mixer containing fine SiO₂ particulate or to a conveyor belt covered in fine SiO₂ particulate. In the case of the conveyor belt, fine particulate of silica is added to cover the hot partially oxidized cores to ensure uniform addition of silica to the seed. In addition, the conveyor belt can be vibrated to ensure the fine particulate silica covers the hot partially oxidized cores to ensure uniform addition of silica to the seed. In either case (mixer or conveyor), the fine SiO₂ particulate adheres to the hot partially oxidized core. The partially oxidized cores with the additional coating of fine silica particles can be recovered by any suitable physical means, for example and without limitation, sieving. The partially oxidized cores with the additional coating of fine silica particles can be reheated in an inert or oxidizing atmosphere or by any of the heating methods described above and further coated with additional fine particulate silica, as described in this ninth production method, until the desired thickness of coating is achieved.

In a tenth example seed production method, hot partially oxidized Si or SiC cores are charged separated (not in clumps) or in clumps to a mixer containing fine particulate glass frit or to a conveyor belt covered in fine particulate glass frit. In the case of the conveyor belt, fine particulate of glass frit is added to cover the hot partially oxidized cores to ensure uniform addition of glass frit to the seed. In addition, the conveyor belt can be vibrated to ensure the fine particulate of glass frit covers the hot partially oxidized cores to ensure uniform addition of glass frit to the seed. In either case (mixer or conveyor), the glass frit adheres to the hot partially oxidized core. The partially oxidized cores with the additional coating of fine particles of glass frit can be recovered by any suitable physical means, for example and without limitation, sieving. The partially oxidized cores with the additional coating of fine particles of glass frit can be reheated in an inert or oxidizing atmosphere or by any of the heating methods described above and further coated with additional glass frit as described in this tenth production method, until the desired thickness of coating is achieved.

In an eleventh example seed production method, hot partially oxidized Si or SiC cores are charged separated (not in clumps) or in clumps to a mixer containing fine particulate an admixture of any combination of elements and compounds, or charged to a conveyor belt covered in fine particulate of an admixture of any combination of elements or compounds. In the case of the conveyor belt, fine particulate of the admixture is added to cover the hot partially oxidized cores to ensure uniform addition of the admixture to the seed. In addition, the conveyor belt can be vibrated to ensure the fine particulate of the admixture covers the hot partially oxidized cores to ensure uniform addition of the admixture to the seed. In either case (mixer or conveyor), the admixture adheres to the hot partially oxidized core. The partially oxidized cores with the additional coating of fine particles of the admixture can be recovered by any suitable physical means, for example and without limitation, sieving. The partially oxidized cores with the additional coating of fine particles of the admixture can be reheated in an inert or oxidizing atmosphere or by any of the heating methods described above and further coated with additional fine particles of the admixture as described in this eleventh production method, until the desired thickness of coating is achieved.

A third group of production methods use a conveyor belt, chamber, or other similar system. The conveyor belt system is advantageously adaptive and can include, but is not limited to, any of the following features. The system can include a conveyor belt, upon which a layer of fine powder of silica, or glass frit, or compounds, or elements, or any combination of the listed materials can be placed. The system can also include a line of lasers above the conveyor belt, and perpendicular to the direction of the belt's movement, with the lasers having the ability to heat material on the belt. The system can additionally or alternatively include a line of 3-dimensional printer nozzles positioned above the belt, and perpendicular to the direction of the belt's movement, that can deposit material on the belt or on the material on the belt. The system can additionally or alternatively include a line of microwave generators positioned above the belt, and perpendicular to the direction of the belt's movement, with the ability to heat material on the belt. The system can additionally or alternatively include a mechanism to vibrate the conveyor belt. The system can additionally or alternatively include a containment for operating the conveyor belt under a controlled atmosphere, temperature, and/or pressure. Indeed, the system can include any combination, any order, and any number of the described features.

In a twelfth example seed production method, a layer of fine powder of silica, or glass frit, or compounds, or elements, or any combination of the listed materials is placed on a conveyor belt. The lasers heat small spots of the fine powder placed on the conveyor belt to a temperature where the particles stick together. Silicon carbide particulate, the particle size being greater than that of the fine powder, is deposited in the center and away of the edges of the hot spots using 3-dimensional printing. The silicon carbide can be heated using a laser or with microwaves if needed. Fine powder of the composition being used is deposited on the silicon carbide using 3-dimensional printing or by laying down a complete layer over the width of the conveyor belt. Lasers are used to heat the fine powder laid down on top of the silicon carbide and around the edges of the carbide to a temperature that causes the fine particles to stick to each other, forming a complete cage around the silicon carbide. The cage is porous, but the pore size is too small for the silicon carbide to escape. The caged silicon carbide is recovered by any suitable physical means, one non-limiting example being sieving. The recovered cages can be heated in an oxidizing gas to convert a small portion of the silicon carbide to silica that bonds with the material forming the cage.

In a thirteenth example seed production method, a layer of fine powder of silica, or glass frit, or compounds, or elements, or any combination of the listed materials is placed on a conveyor belt. The lasers heat small spots of the fine powdered placed on the conveyor belt to a temperature where the particles of the powder fuse together forming a non-porous structure. Silicon carbide particulate is deposited in the center and away of the edges of the hot spots using 3-dimensional printing. The silicon carbide can be heated using a laser or with microwaves if needed. Additional fine powder of the composition originally placed on the belt is deposited on the silicon carbide using 3-dimensional printing, or by laying down a complete layer over the width of the conveyor belt. Lasers are used to heat the additional fine powder laid down on top of the silicon carbide and around the edges of the carbide to a temperature that causes the fine particles of the powder to fuse to each other forming a complete cage around the silicon carbide. The cage is non-porous. The caged silicon carbide is recovered by any suitable physical means, one non-limiting example being sieving.

In a fourteenth example seed production method, a layer of fine powder of silica, or glass frit, or compounds, or elements, or any combination of the listed materials is placed on a conveyor belt. The lasers heat small spots of the fine powder placed on the conveyor belt to a temperature where the particles stick together. Silicon particulate, the particle size being greater than that of the fine powder, is deposited in the center and away of the edges of the hot spots using 3-dimensional printing. The silicon can be heated using a laser or with microwaves if needed. An additional quantity of the fine powder is deposited on the silicon carbide using 3-dimensional printing or by laying down a complete layer over the width of the conveyor belt. Lasers are used to heat the powder laid down on top of the silicon and around the edges of the silicon to a temperature that causes the fine particles to stick to each other, forming a complete cage around the silicon. The cage is porous, but the pore size is too small for the silicon to escape. The caged silicon is recovered by any suitable physical means, one non-limiting example being sieving. The recovered cages can be heated in an oxidizing gas to convert a small portion of the silicon carbide to silica that bonds with the material forming the cage.

In a fifteenth example seed production method, a layer of fine powder of silica, or glass frit, or compounds, or elements, or any combination of the listed materials is placed on a conveyor belt. The lasers heat small spots of the fine powder placed on the conveyor belt to a temperature where the particles of the powder fuse together forming a non-porous structure. Silicon particulate is deposited in the center and away of the edges of the hot spots using 3-dimensional printing. The silicon can be heated using a laser or with microwaves if needed. An additional quantity of the fine powder is deposited on the silicon using 3-dimensional printing, or by laying down a complete layer over the width of the conveyor belt. Lasers are used to heat the powder laid down on top of the silicon and around the edges of the silicon to a temperature that causes the fine particles of the powder to fuse to each other forming a complete cage around the silicon. The cage is non-porous. The caged silicon is recovered by any suitable physical means, one non-limiting example being sieving.

In a sixteenth example seed production method, a layer of fine powder of glass frit, or compounds, or elements, or any combination of the listed materials is placed on a conveyor belt. The lasers heat small spots of the fine powder placed on the conveyor belt to a temperature where the particles stick together. Calcium carbonate particulate, the particle size being greater than that of the fine powder is deposited in the center and away of the edges of the hot spots using 3-dimensional printing. The calcium carbonate can be heated using a laser or with microwaves if needed. An additional quantity of the fine powder is deposited on the calcium carbonate using 3-dimensional printing or by laying down a complete layer over the width of the conveyor belt. Lasers are used to heat the powder laid down on top of the calcium carbonate and around the edges of the carbonate to a temperature that causes the fine particles to stick to each other, forming a complete cage around the calcium carbonate. The cage is porous, but the pore size is too small for the calcium carbonate to escape. The caged calcium carbonate is recovered by any suitable physical means, one non-limiting example being sieving.

In a seventeenth example seed production method, a layer of fine powder of glass frit, or compounds, or elements, or any combination of the listed materials is placed on a conveyor belt. The lasers heat small spots of the fine powdered placed on the conveyor belt to a temperature where the particles of the powder fuse together forming a non-porous structure. Calcium carbonate particulate is deposited in the center and away of the edges of the hot spots using 3-dimensional printing. The calcium carbonate can be heated using a laser or with microwaves if needed. An additional quantity of the fine powder of the composition is deposited on the calcium carbonate using 3-dimensional printing, or by laying down a complete layer over the width of the conveyor belt. Lasers are used to heat the powder laid down on top of the calcium carbonate and around the edges of the carbonate to a temperature that causes the fine particles of the powder to fuse to each other forming a complete cage around the calcium carbonate. The cage is non-porous. The caged calcium carbonate is recovered by any suitable physical means, one non-limiting example being sieving.

In an eighteenth example seed production method, a layer of fine powder of glass frit, or compounds, or elements, or any combination of the listed materials is placed on a conveyor belt. The lasers heat small spots of the fine powder placed on the conveyor belt to a temperature where the particles of the powder fuse together forming a non-porous structure. A mixture of carbon and magnetite particulate is deposited in the center and away of the edges of the hot spots using 3-dimensional printing. The mixture of carbon and magnetite particulate can be heated using a laser or with microwaves if needed. An additional quantity of the fine powder is deposited on the mixture of carbon and magnetite particulate using 3-dimensional printing, or by laying down a complete layer over the width of the conveyor belt. Lasers are used to heat the powder laid down on top of the mixture of carbon and magnetite particulate and around the edges of the mixture to a temperature that causes the fine particles of the powder to fuse to each other forming a complete cage around the carbon and magnetite. The cage is nearly non-porous. The caged mixture of carbon and magnetite particulate is recovered by any suitable physical means, one non-limiting example being sieving.

A fourth group of seed production methods includes the use of adhesive(s). In particular, the twelfth through the eighteenth example seed production methods, one or more adhesives can be used to fuse (or stick) particles together, instead of the described lasers. The use of lasers can be wholly or partially replaced with application of adhesive. Adhesive can be applied using 3-dimensional printer nozzles or similar devices. An additional heating operation by laser can be used at the end of constructing the seed to cause the coating particles surrounding the core to adhere to each other. The coating, after heating with the laser, can be either porous or nonporous.

A fifth group of seed production methods uses microwaves instead of lasers for heating. The use of lasers and 3-dimensional printing in previously described methods limits production of seeds to a two dimensional surface, whereas use of microwaves for heating facilitates production on a three dimensional basis, because microwaves can penetrate fused silica and glass frit.

In a nineteenth example seed production method, a mixture of cores and coating material is prepared. The mixture can be homogeneous. The core, wholly or partially absorbs microwave energy. The coating is substantially transparent or at least partially transparent to microwaves. A fused silica tray that will contain the mixture of cores and coating material is first dusted with fine powder of silica or similar material as a release agent to eliminate any sticking of seeds to the tray after microwave treatment. The mixture is placed in a layer on the fused silica tray. The tray with the mixture is exposed to microwaves. The source of microwaves can be positioned above, below, or both above and below the tray.

Application of the microwaves can be conducted under an inert or oxidizing atmosphere. Use of an oxidizing atmosphere with SiC and Si cores has the advantage of producing a layer of SiO₂ on the core material, ensuring that the core is completely surrounded by a nearly nonporous coating, and a layer that also can bond with other surrounding particulate to further increase the thickness of the coat. This example is one of many possibilities and is not intended to be limiting. When using an oxidizing atmosphere with Si cores coated in carbon, the carbon initially absorbing microwaves becomes hot heating the Si core and generates additional heat through chemical reaction with the oxidizing atmosphere producing CO₂ and CO gases. The heat generated by the combined effects raises the temperature of the Si core to a temperature above 700° C. where the silicon takes on metallic characteristics and can now absorb microwaves leading to further heating of the Si core. This example is one of many useful variations and is not intended to be limiting.

Whether under an inert or oxidizing atmosphere, the tray is exposed to the microwaves until the core is heated to a point where the surrounding coating material forms a porous or nonporous cage around the core of desired thickness and porosity. After the tray is exposed to microwaves, it is allowed to cool and the caged cores are recovered by any suitable physical means, one non-limiting example being sieving.

In a twentieth example seed production method, separate powders for core and coating materials are prepared. The core, wholly or partially absorbs microwave energy. The coating is transparent or partially transparent to microwaves. A fused silica tray that will contain the powders is first dusted with fine powder of silica or similar material as a release agent to eliminate any sticking of seeds to the tray after microwave treatment. The coating powder is laid down in a layer on the fused silica tray. Core particles are sprinkled on top of the coating layer to the desired surface coverage. Additional layers of coating powder and core particles are repeatedly laid down in sequence, with the last layer being that of coating powder, until the desired thickness of the overall layer is achieved. The tray with the core and coating material is exposed to microwaves. The source of microwaves can be above, below, or both above and below the tray.

Application of the microwaves can be conducted under an inert or oxidizing atmosphere. Use of an oxidizing atmosphere with SiC and Si cores has the advantage of producing a layer of SiO₂ on the core material, ensuring the core is completely surrounded by a nearly nonporous to nonporous coating, and a layer that also can bond with other surrounding particulate to further increase the thickness of the coat. This example is one of many useful variations and is not intended to be limiting. When using an oxidizing atmosphere with Si cores coated in carbon, the carbon initially absorbing microwaves becomes hot, thereby heating the Si core, and generates additional heat through chemical reaction with the oxidizing atmosphere producing CO₂ and CO gases. The heat generated by the combined effects raises the temperature of the Si core to a temperature above 700° C. where the silicon takes on metallic characteristics and can now absorb microwaves leading to further heating of the Si core. This example is one of many useful variations and is not intended to be limiting.

Whether the application of microwaves is conducted under an inert or oxidizing atmosphere, the tray is exposed to the microwaves until the core is heated to a point where the surrounding coating material forms a porous or nonporous cage around the core of desired thickness and porosity. After the tray is exposed to microwaves, it is allowed to cool and the caged cores recovered by any suitable physical means, one non-limiting example being sieving.

Several example applications will now be provided. The given examples are intended to illustrate certain aspects of the inventions disclosed herein, to enable those skilled in the art to practice the inventions as described and to apply the inventions to material compositions and processes that differ from the specific examples presented. Therefore, the examples provided herein are not intended to be limiting and should not be considered to be limiting.

### Example 1: The Plasma Torch

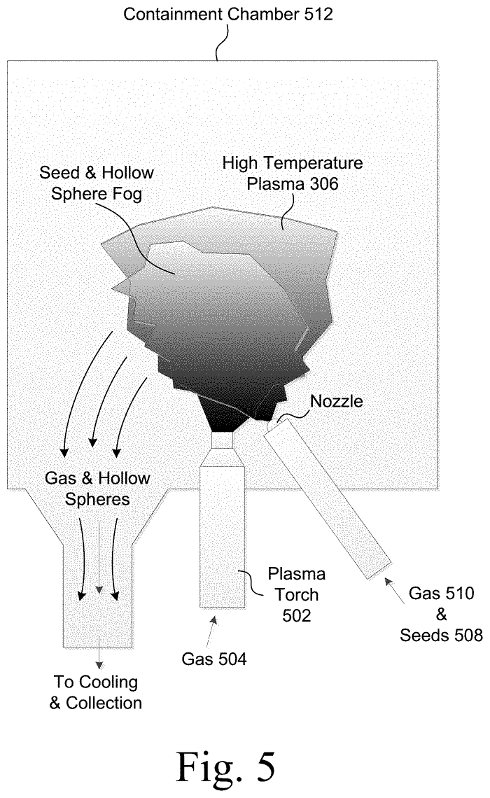

FIG. 5 shows an apparatus for converting individual seeds to hollow spheres using plasma torch 502. In this example, plasma torch 502 is a non-transferred arc plasma torch, which provides the thermal energy for both the chemical reaction that occurs within or at the exterior surface of the core, and the sensible heat to raise the seed to the required temperature. A gas 504 (inert, or oxidizing, or specialty gas) is passed through the plasma torch 502 producing a large and high temperature plasma 306 plume of swirling superheated ionized gaseous atoms. The rapid mixing occurring in the plasma 306 leads to rapid heating of the surface of the seeds to a temperature where the viscosity of a portion of the seeds coating is low enough to respond to the gas pressure as it increases as the temperature of the core increases. The chemical reactions in core chemistries (a) through (k) in the section entitled “Core Chemistry” are endothermic reducing the temperature of the core as the reaction proceeds. The temperature of the core, upon heating, lags that at the exterior surface of the seed. That combination of rapid heating at the surface of the seed and the endothermic reaction in the core reduces the need to operate the plasma torch at pressures greater than 1 atmosphere as explained above.

Elutriation is used to inject seeds 508 into the plasma. The gas 510 used to elutriate the seeds 508 reduces the temperature of the plume to that required to achieve the desired viscosity of the silica (or glass) to initiate the growth of the hollow spheres from their seeds. The process is carried out within a containment chamber 512, which facilitates control of the process environment.

### Example 2: Bulk Heating with Constrained Expansion

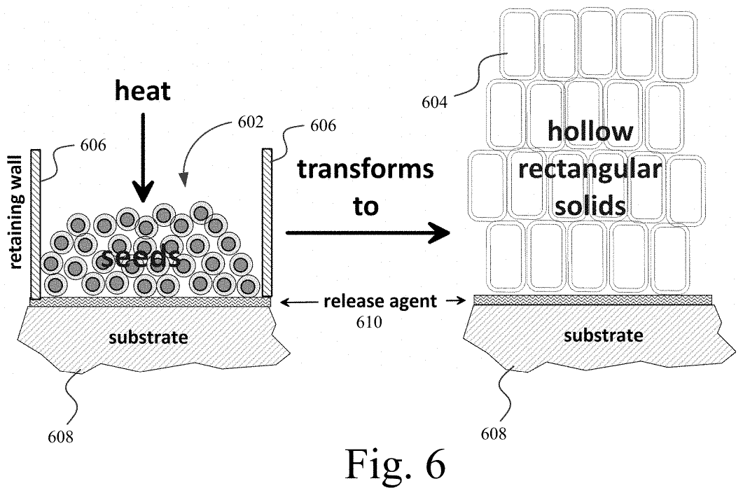

FIG. 6 shows how confined expansion of seeds 602 to hollow “spheres” can distort the shape of the hollow sphere 604, as well as produce a bulk form with little or no voids between expanded cells. In the example of FIG. 6, seeds 602 are horizontally confined, on all four sides, by retaining walls 606. The front and back retaining walls are omitted for the view of FIG. 6 to avoid obscuring the view of seeds 602. Expansion is constrained on the bottom by a substrate 608, which is isolated from seeds 602 by a releasing agent 610, which prevents seeds 602 from sticking to substrate 608.

Conversion of seeds in a confined space will produce a product with minimal open porosity. Open porosity is the unoccupied volume between hollow cells. In FIG. 6, seeds 602 are converted under conditions where horizontal growth is fixed by retaining walls 606. Seeds 602, upon conversion, expand their volume. Due to the horizontal confinement, the seeds upon expansion urge against one another and can merge with one another, leaving only expansion in the vertical direction. The result is production of hollow rectangular solids 604, or similar structures, with minimal voids between expanded structures. As expansion occurs, the free space is eliminated, or at least reduced, and the walls between cells bond to each other, leaving a honeycomb type structure. In FIG. 6 heating is from the top of the seeds, but heating can be from any direction and by any suitable means, including, but not limited to, the heating means used in the seed production methods described above.

The honeycomb type structure can be used to replace and/or augment fiber cement siding. Use of the sealed and honeycomb structure in siding eliminates damage from the wet-freeze-thaw cycle experienced with fiber cement siding. This new approach to producing siding with respect to fiber cement siding can: reduce the weight of siding by 85 to 96%; and reduce CO₂ emissions during production by 69 to 92%.

### Example 3: Restricted Heating with Unconstrained Expansion

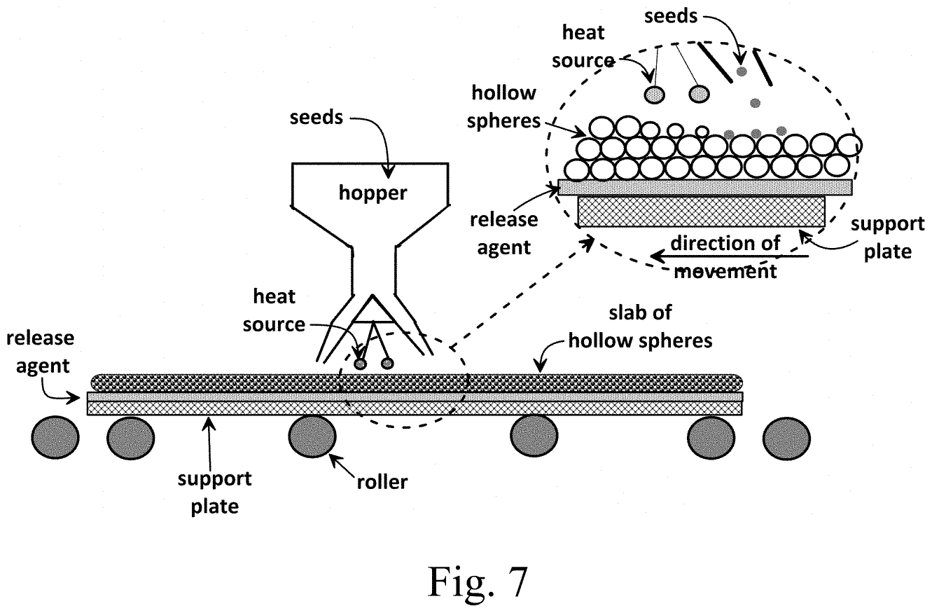

FIG. 7 illustrates an example method and apparatus for converting seeds to hollow spheres, while forming layered sheets of hollow spheres. The resulting product contains continuous voids that can be infused with other materials for forming micro-composites. While the drawing provides for depositing a single row of seeds for clarity, multiple rows can be deposited and heated simultaneously.

In this example hollow spheres are grown line by line, much like how a television forms a picture. FIG. 7 shows a cross-sectional view of the example method and apparatus. The hopper distributes a line of seeds that is perpendicular to the view of FIG. 7 (i.e., perpendicular to the plane of the page). The heating source also extends in a line perpendicular to the view of FIG. 7 and, therefore, parallel to the line of seeds. The heating source can be radiative, a laser, or any other heat source capable of delivering heat along a controlled line.

A large sheet of hollow spheres can be formed, line by line, on the moving support plate, as shown in FIG. 7. The line of seeds is deposited on the previous sheet of seeds that were converted to hollow spheres. Heating can be restricted to one or two layers such that the hollow spheres formed on previous passes are not significantly altered, and that the newly grown hollow spheres can bond to the walls of the spheres below, to the preceding row of spheres in the same layer, and to the hollow spheres to their right and left. This approach allows for three-dimensional bonding between the hollow spheres, providing cohesion to each layer of hollow spheres and overall strength to the multilayered product.

This approach produces a sheet of hollow spheres in a near close-pack structure with approximately 26 volume percent interconnected voids. As a result, this sheet material can be infused with molten metal, metal powders, gypsum slurry, polymers, fiber cement, and ceramic slip to produce micro-composites with metals, drywall, plastics, cement, and ceramics. This list is not intended to limit potential uses, but only to illustrate useful examples for the hollow spheres with an open porosity.

### Example 4: Layered Sheets of Hollow Spheres

In this example hollow spheres as produced in Example 1 (as opposed to seeds) are deposited in sheets as presented in Example 3. Heating can be restricted to one or two layers such that the hollow spheres deposited on previous passes are not significantly altered, and that the newly deposited hollow spheres can bond to the walls of the spheres below, to the preceding row of spheres in the same layer, and to the hollow spheres to their right and left. This approach allows for three-dimensional bonding between the hollow spheres, providing cohesion to each layer of hollow spheres and overall strength to the multilayered product. An entire layer of seed can be processed at one time since converting seed to hollow sphere is not involved.

This approach also produces a sheet of hollow spheres in a near close-pack structure with approximately 26 volume percent interconnected voids. This sheet material can be infused with molten metal, metal powders, gypsum slurry, polymers, cement, and ceramic slip to produce micro-composites with metals, drywall, plastics, cement, and ceramics. This list is not intended to limit potential uses, but only to illustrate useful examples for the hollow spheres.

### Example 5: Reducing the Firing Temperature of Bricks

A method is presented whereby clay bricks, using existing infrastructure, can be produced at reduced firing temperature, and, thus, reduced carbon dioxide emissions, by the inclusion of seeds in green bricks. The conversion of seeds to hollow structures enhances the physico-chemical processes that produce the desired compressive strength in bricks, but at lower temperatures. Green bricks are stacked, heated to a desired temperature, soaked at the temperature for a specific period, and then gradually cooled. The soak temperature and soak time can be reduced through inclusion of seeds in the mud used to produce the green bricks.

An example composition of the mud used by pugmills producing green bricks by the extrusion process consists of: 50 to 60 wt % sand, 20 to 30 wt % alumina (clay), 2 to 5 wt % lime, <7 wt % iron oxide, and <1 wt % magnesia. To this mix 10 to 15% water is added for stiff extrusion or 20 to 25% for soft extrusion. Clay composition will vary with location, one clay used in making bricks consists mainly of Kaolinite (Al₂(Si₂O₅)(OH)₄) and silica (SiO₂). Other minerals in the clay can include microline (KAlSi₃O₈) and muscovite [K(Mg,Al)_{2.04}(Si_{3.34}Al_{0.66})O₁₀(OH)₂].

The water, lime, and potassium content play important roles in producing brick. First, the water content in the mix (creating mud) is the basis for modern high-speed extrusion of 25,000 green bricks per hour at a single pugmill. Initially, as heating of the green bricks begins, free water and water in the pores is evaporated up to a temperature 290° C. At 350° C. the hydrated water, that water which is weakly bonded to the clay, starts to be driven off. Above 660° C. dehydroxylation [2OH⁻→H₂O(g)+O²⁻, the O²⁻ anion bonds with Ca²⁼, 2K⁻, or 2Na⁼ cations] begins producing basic oxides that can react with and reduce the viscosity of aluminosilicate glass.

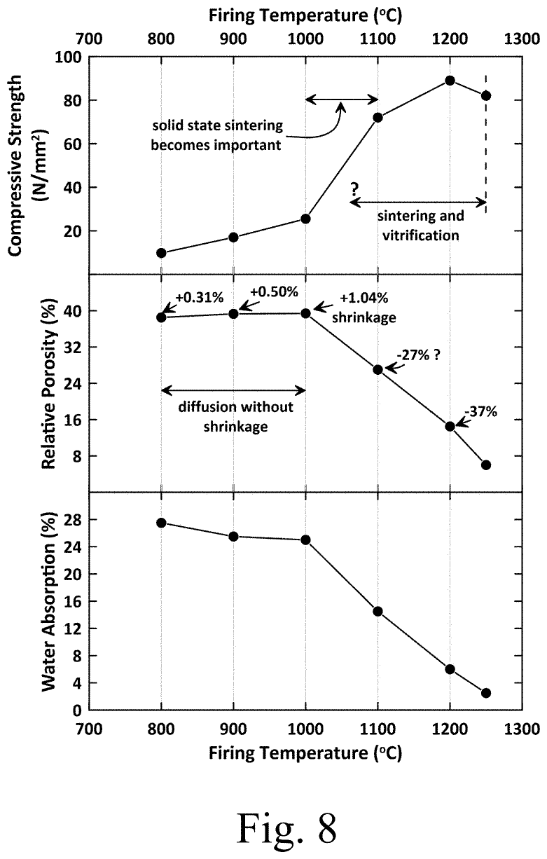

FIG. 8 shows graphs of properties of bricks as they undergo firing. In certain clays the dihydroxylation begins at higher temperatures than other clays. As indicated by the graphs in FIG. 8, the elimination of the hydroxyl ion begins at a temperature near 1000° C. (a temperature at which clay decomposes to its constituent molecular compounds). The process leads to densification, pore loss, and increased compressive strength as solid-state diffusion begins with the formation of the basic oxides (CaO, MgO, K₂O, and Na₂O). The dehydroxylation leads to small pockets of near pure basic oxides that immediately begin the solid-state diffusion process to reduce their activity by intermixing, through diffusion, with the other basic oxides and the aluminosilicate, which forms with the decomposition of the kaolinite, and with the mixing vitrification begins. During cooling the liquid coating the particles undergoes devitrification, and where particles were only in contact before, they are now bonded to each other.

SEM analysis of the fired bricks is reported to indicate that evidence of devitrification was first observed in bricks fired at 1100° C. Thus, in the top graph in FIG. 8 the bar representing temperatures over which “sintering and vitrification” occurred has a question mark on its left end as it is unknown what temperature vitrification initially occurred. It is also reported that the significant increase in compressive strength from 1000 to 1200° C. was due to bonding between particles because of solid-state diffusion and the devitrification upon the cooling of the bricks.

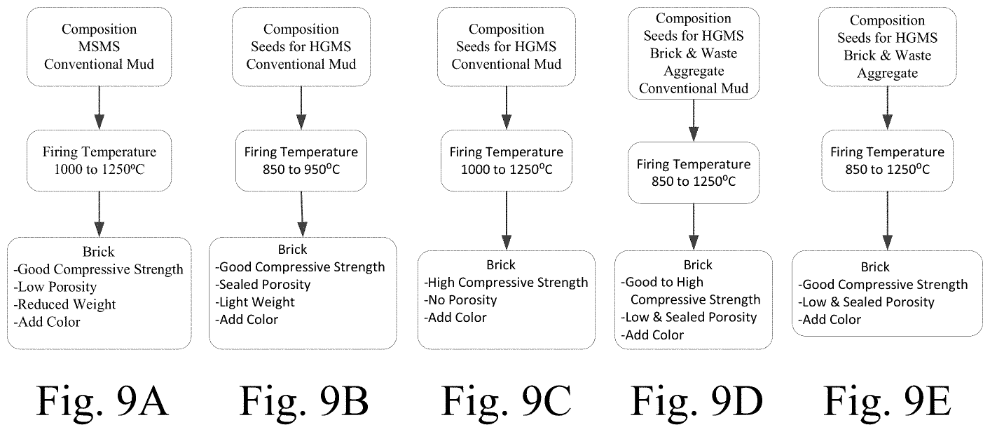

FIGS. 9A-9E show a series of simplified flow diagrams, summarizing methods for including hollow spheres in the formation of bricks. Flow diagrams (a) through (d) rely on an existing extrusion process, whereas the process presented in flow diagram (e) requires pressing of green bricks before firing. Comparative language is with respect to conventionally produced bricks. For example, “light weight” means lighter than a similarly-sized conventional brick.

The diagrams show the mix to form the green bricks, firing temperature, and physical properties of the fired bricks. The composition of the mix used to produce the green bricks in flow diagrams (a) through (d) include a significant portion of the conventional clay, sand, and water mixture so as to be able to use existing pugmills in extruding bricks. If seeds for HSMS and HGMS are to be used in producing bricks to decrease both energy demand and CO₂ emissions, it is advantageous to make it economical for producers to do so. Any technology that disrupts production will not be voluntarily adopted by producers, particularly if it increases cost.

FIG. 9A shows that HSMS, with their high operational temperature, can be included in the mud used to produce green bricks by extrusion. Some chemical interaction is anticipated as vitrification takes place at higher firing temperatures. The primary impact of the hollow spheres is to reduce the weight of the bricks without adding open porosity. There will be some energy saving in the firing process as the hollow spheres reduce the specific heat of the green bricks. However, any energy saving, and associated reduction in CO₂ emission is offset by the energy consumption and CO₂ emission associated with producing the HSMS. Bricks manufactured according to FIG. 9A will have good compressive strength, low porosity, reduced weight, and can be colored. Advantages of the method of FIG. 9A include the manufacture of bricks with reduced weight, but without an increase in porosity. Disadvantages of the method of FIG. 9A include no improvement in energy consumption or reduction in CO₂ emissions.

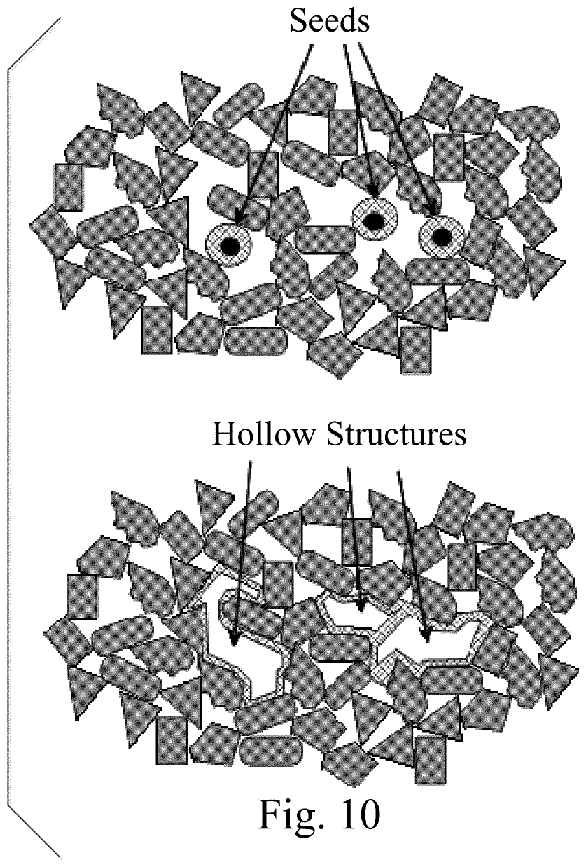

FIG. 9B shows that seeds for forming HGMS can be included in the mud for extrusion of the green bricks. The seeds begin to transform into hollow spheres at temperatures below 900° C. The expansion of the hollow sphere is restrained by surrounding particles and the viscosity of the glass forming the hollow structure. The hollow structures conform to the open area surrounding the seed as shown in FIG. 10, thereby sealing pores. Heating transforms seeds to hollow structures that seal pores, reduce water absorption, and improve the compressive strength of the brick through chemical bonding. Water absorption will decrease in relation to the extent that pores are sealed by the hollow structures.

The molten glass of the hollow structures is in contact with the grains of clay and sand. The glass acts as a solvent, dissolving and reacting with some of the clay and sand at temperatures significantly below that for normal vitrification. The chemical interaction leads to some shrinkage, and upon cooling the glass that has reacted with the other materials undergoes devitrification, improving the compressive strength of the brick through bonding that now extends from particle to particle. The extent of interaction between the walls of the hollow structures and the other minerals in the brick depends on the number of seeds in the green bricks and the duration of the soaking time at the desired firing temperature.

The weight of stacked bricks during the firing process prevents any internal forces created with the conversion of the seeds from causing damage. Bricks manufactured according to FIG. 9B will have good compressive strength, sealed porosity, light weight, and can be colored. Advantages of the method of FIG. 9B include the manufacture of bricks with a reduction in open porosity, reduced water absorption, improved compressive strength, the manufacturing process having reduced energy consumption and CO₂ emissions. A disadvantage of the method of FIG. 9B is that some open porosity remains for water absorption.

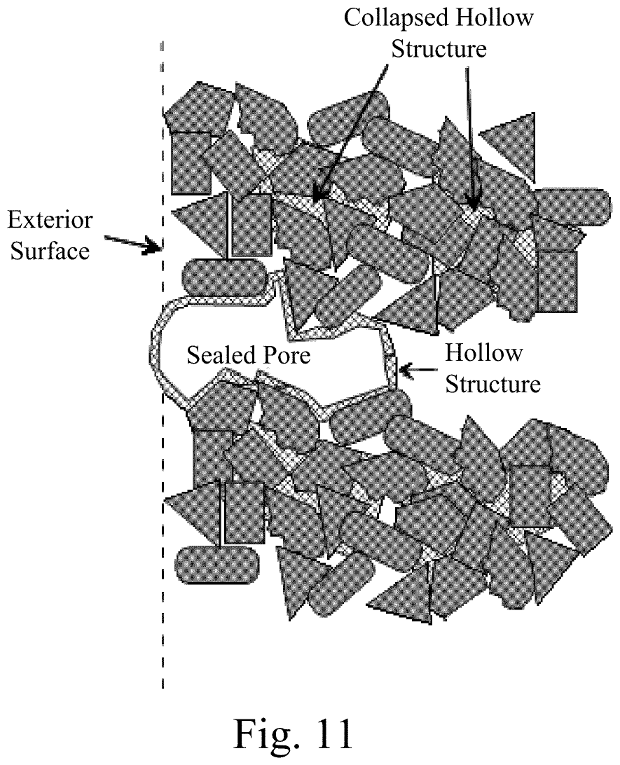

The method of FIG. 9C has a different firing temperature than the method of 9B. Again, seeds for forming HGMS are included in the mud for extrusion of the green bricks. The seeds begin to transform into hollow spheres at temperatures below 900° C. The expansion of the hollow sphere is restrained by surrounding particles. The hollow spheres conform to the open area surrounding the seed as shown in FIG. 10, thereby sealing pores, as shown in FIG. 11. However, with further heating the walls of the hollow structures become more fluid. The walls of the hollow structure flow between particles of clay and sand as shrinkage occurs as shown in FIG. 11, and as the temperature increases vitrification of those particles with the molten glass is increased. That process leads to significant shrinkage, sealed pores, high compressive strength, and literally no capacity for water absorption. As shown in FIG. 11, a higher firing temperature produces more chemical interaction between the molten glass and the clay and sand particles leading to shrinkage, so that the few remaining pores are sealed. Many of the hollow structures, now wetting many particles have the appearance of having collapsed as shrinkage has squeezed the hollow structure between the declining spaces between particles.

The weight of stacked bricks during the firing process prevents any internal forces created with the conversion of the seeds from causing damage. Advantages of the method of FIG. 9C include the manufacture of bricks with reduced porosity and sealed pores, no water absorption, high compressive strength, and the manufacturing process having reduced energy consumption and CO₂ emissions.

FIG. 9D summarizes a process that is similar to process presented in FIGS. 9B and 9C except that some construction and demolition debris (CDD) is used in preparing the green bricks. The weight of stacked bricks during the firing process prevents any internal forces created with the conversion of the seeds from causing damage. An advantage of the process of FIG. 9D is that it reduces the amount of CCD going to landfill. This method also has advantages similar to the advantages of the methods of FIGS. 9B and 9C (e.g., reduced porosity, sealed pores, and so on), depending on firing temperature. On possible disadvantage is some reduction in compressive strength as compared to the method of FIG. 9C.

FIG. 9E summarizes a fifth example method of manufacturing bricks. Bricks formed with seeds for HGMS and CDD, and without mud must be pressed in molds to achieve shape before firing. This approach is not only capital intensive, but the savings in cost of using CDD does not offset that additional expense. Moreover, the physical properties of the fired brick will vary with the composition and quality of the CDD. An advantage of this method is that it reduces CDD going to landfill. Disadvantages include higher capital expense and uncertain properties of the fired bricks.

Reuse of Bricks as Bricks Versus as Aggregate:

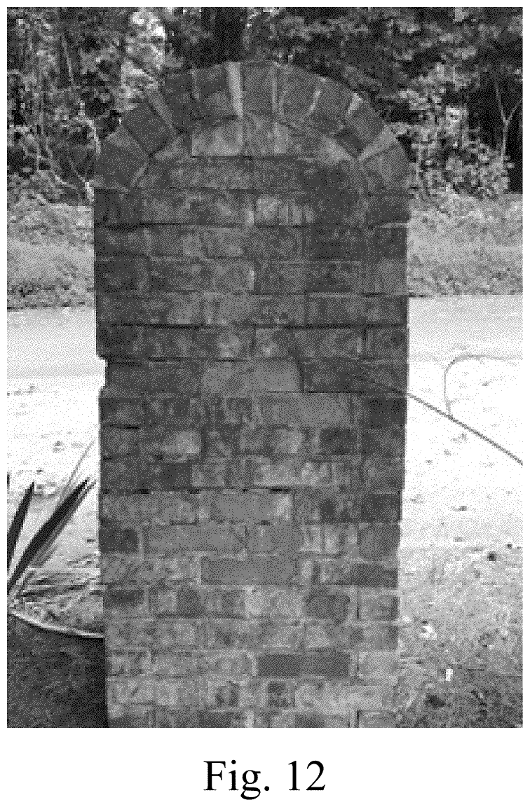

There is no commercial recycling of bricks as bricks in the Western World, because there is legitimate concern regarding the structural integrity of the bricks after decades of use. The integrity of bricks is compromised by the wet-freeze-thaw cycle. Water expands upon freezing, and when that occurs within the pores of a brick, particles that form the pore are put in tension. Cracks concentrate tensile stress that can propagate a crack and weaken the brick. This leads to spalling of surface material that exposes a new surface to the wet-freeze-thaw cycle. The process repeats itself and with time will either destroy a brick or leave it intact but weakened. An example of the impact of the wet-freeze-thaw cycle is shown in FIG. 12. By producing bricks that have sealed porosity, the damage of the wet-freeze-thaw cycle is eliminated, or at least reduced to the point that recycle of bricks as bricks becomes possible.

Impact of Pores:

In the previous section the impact of pores and the wet-freeze-thaw cycle was identified. Pores also impact the use of bricks in two other ways. When laying bricks using mortar the smaller pores in the brick can draw water away from the mortar. That loss of water can produce a weak mortar. However, when mortar is drawn into the larger pores it serves to lock the brick in place. With sealed pores that is not possible.

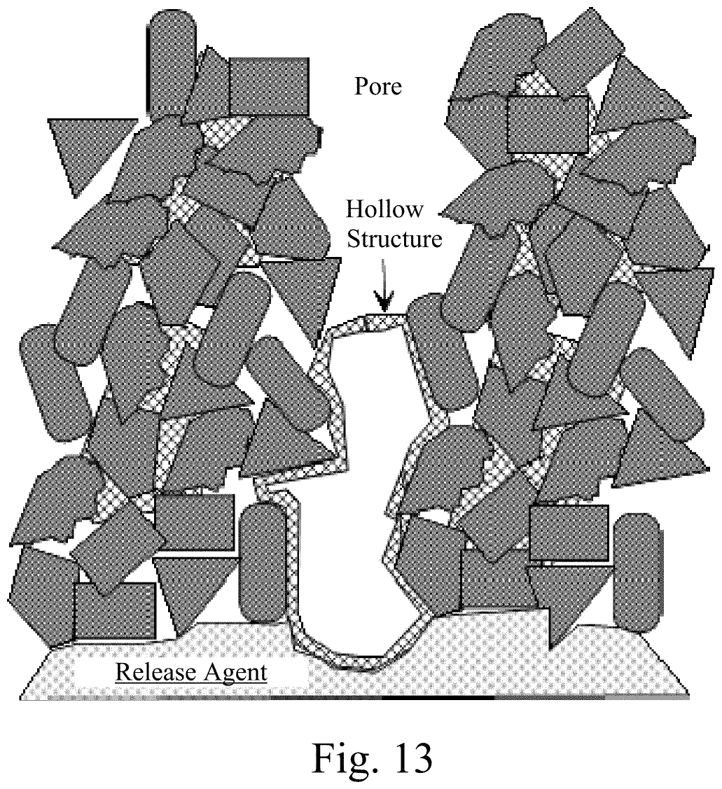

Sealed pores can produce their own locking mechanism. As shown in FIG. 13, silica sand serving as a release agent can attach to the expanding hollow structure and can be used as a locking mechanism. When green bricks are stacked, a release agent can be placed between layers to prevent the bricks from sticking to each other. The growth of the hollow structure shown in FIG. 11 can react with an adjacent brick. By placing a thin layer of silica sand between the layers, as shown in FIG. 13, the growth of the hollow structure leads to sand grains being physically attached to the exterior surface of the hollow structure. That trapped sand will lock the brick in place when laid with mortar.

An alternative approach is to wire brush (or otherwise abrade) the surface of the brick to partially open the pore in FIG. 13, by opening a portion of the hollow structure. The open pore will allow some mortar to enter, thereby locking the brick in place. The opening of the hollow structure still leaves nearly all the pore structure sealed, and thus very little water absorption can occur. The surface of the fired brick visible to the public can be wire brushed to achieve a uniform appearance.

Cosmic Curtain & Global Cooling:

A cosmic curtain, reflecting photons from the Sun, would consist of hollow silica microspheres (HSMS) or hollow glass microspheres (HGMS) either orbiting the Earth or the Sun. With respect to the latter choice, the curtain would orbit the Sun, synchronized with the Earth such that it always existed between the two bodies, and positioned as near as possible to the Sun to minimize its size and mass. A cosmic curtain orbiting the Earth would require strict positioning; allowing satellites to safely orbit the Earth as well as allow space craft to safely leave earth's orbit for other planets.

Only seeds need to be delivered to space. Solar heating of the seeds can be used to achieve the transformation. The process for converting seeds to hollow spheres in space can be engineered to take place in minutes, or decades, or centuries. The positioning of the seeds in space requires matching viscosity of the coating and the pressure or the gas created by the core as per the conditions specified herein above.

This approach of sending seeds into space has the advantage in that the bulk volume of the seeds is very small in comparison to the bulk volume of hollow spheres; impacting the size of the cargo rockets that transfer the seeds to their point of dispersal.

The description of particular embodiments of the present invention is now complete. Many of the described features may be substituted, altered or omitted without departing from the scope of the invention. For example, alternate core and coating compositions, may be substituted for the example compositions disclosed. As another example, other methods and apparatus can be used to transform the seeds into hollow spheres. These and other deviations from the particular embodiments shown will be apparent to those skilled in the art, particularly in view of the foregoing disclosure.

I claim:

1. A method for producing a seed capable of transformation into a hollow structure, said method including:
providing a core having a particular composition that when heated reacts to generate a gas; and
forming a coating around said core, said coating having a particular composition that when heated will fuse to form a continuous shell surrounding said core and trapping said gas generated by said core within said shell; and wherein
said trapped gas will produce a temperature dependent pressure within said shell;
said particular composition of said coating has a temperature dependent viscosity;
a first temperature corresponds to a working point of said particular composition of said coating;
a second temperature corresponds to a fluid point of said particular composition of said coating;
a third temperature corresponds to an equilibrium point where said pressure generated by said trapped gas within said shell is equal to a pressure outside of said shell; and
said particular composition of said core and said particular composition of said coating are selected so that said third temperature is greater than or equal to said first temperature, and said third temperature is less than said second temperature.

2. The method of claim 1, wherein said pressure generated by said gas at said equilibrium point is one atmosphere.

3. The method of claim 1, wherein said particular composition of said core and said particular composition of said coating are selected so that third temperature is equal to said first temperature.

4. The method of claim 1, wherein said step of forming said coating around said core includes oxidizing a surface of said core to produce an oxidized core.

5. The method of claim 4, wherein said step of forming said coating around said core includes heating said core in the presence of an oxidizing gas.

6. The method of claim 5, wherein heating said core in the presence of said oxidizing gas includes heating said core with a laser.

7. The method of claim 5, wherein heating said core in the presence of said oxidizing gas includes heating said core with microwaves.

8. The method of claim 4, further comprising:
heating said oxidized core to a temperature sufficient to adhere SiO₂ particulate to said oxidized core; and
mixing said heated oxidized core with SiO₂ particulate to produce a coated core.

9. The method of claim 8, further comprising:
re-heating said coated core to a temperature sufficient to adhere additional SiO₂ particulate to said coated core; and
mixing said re-heated coated core with SiO₂ particulate to produce a thicker coating of SiO₂ on said coated core.

10. The method of claim 4, further comprising:
heating said oxidized core to a temperature sufficient to adhere particulate glass frit to said oxidized core; and
mixing said heated oxidized core with particulate glass frit to produce a coated core.

11. The method of claim 10, further comprising:
re-heating said coated core to a temperature sufficient to adhere additional particulate glass frit to said coated core; and
mixing said re-heated coated core with particulate glass frit to produce a thicker coating of glass frit on said coated core.

12. The method of claim 4, further comprising:
heating said oxidized core to a temperature sufficient to adhere particulate of an admixture to said oxidized core; and
mixing said heated oxidized core with particulate of an admixture to produce a coated core.

13. The method of claim 12, further comprising:
re-heating said coated core to a temperature sufficient to adhere additional particulate admixture to said coated core; and
mixing said re-heated coated core with particulate admixture to produce a thicker coating of admixture on said coated core.

14. The method of claim 1, wherein said step of forming said coating around said core includes:
placing a fine powder of said particular composition of said coating on a conveyor, said conveyor being operative to move said fine powder along a first direction;
heating spots of said fine powder to a temperature sufficient to cause the particles of the fine powder to stick together;
depositing particulate of said particular composition of said core at the center of the heated spots;
depositing an additional quantity of said fine powder of said particular composition of said coating over said deposited particulate of said particular composition of said core; and
reheating said spots with said particulate of said composition of said core and said additional quantity of said fine powder deposited thereover to form said coating around said core.

15. The method of claim 14, wherein said heating is accomplished with one or more lasers.

16. The method of claim 15, wherein said heating is accomplished with a linear array of lasers disposed over said conveyor and oriented transversely with respect to said first direction.

17. The method of claim 14, wherein said depositing particulate of said particular composition of said core is accomplished with a linear array of printer nozzles disposed over said conveyor and oriented transversely with respect to said first direction.

18. The method of claim 14, wherein said coating around said core is porous.

19. The method of claim 14, wherein said coating around said core is non-porous.

20. The method of claim 14, further comprising:
physically separating said core with said coating from said fine powder; and
reheating said separated core with said coating to bond said coating to said core.

21. The method of claim 14, wherein a particulate size of said particulate of said particular composition of said core is larger than a particulate size of said fine powder.

22. The method of claim 14, wherein said particular composition of said core includes at least one of silicon carbide, silicon, calcium carbonate, and a mixture of carbon and magnetite.

23. The method of claim 1, wherein said step of forming said coating around said core comprises:
providing a mixture including particulate of said particular composition of said core and a powder of said particular composition of said coating;
placing said mixture in a container; and
irradiating said mixture with microwaves.

24. The method of claim 23, wherein said container is a fused silica container.

25. The method of claim 23, further comprising applying a release agent to an interior of said container prior to placing said mixture in said container.

26. The method of claim 25, wherein said release agent includes a powder of silica.

27. The method of claim 23, wherein:
said container is at least partially transparent to said microwaves;
said particulate of said composition of said core absorbs said microwaves; and
said powder of said particular composition of said coating is at least partially transparent to said microwaves.

28. The method of claim 23, wherein said mixture is irradiated with said microwaves in an oxidizing atmosphere.

29. The method of claim 23, wherein said mixture is irradiated with said microwaves in an inert atmosphere.

30. The method of claim 23, wherein said step of irradiating said mixture with microwaves includes irradiating said mixture with microwaves from at least two different directions.

31. The method of claim 23, wherein said steps of providing said mixture and placing said mixture in said container includes placing alternating layers of said powder of said particular composition of said coating and said particulate of said particular composition of said core in said container.

32. A method for producing an article of manufacture having hollow spheres embedded therein, said method including:
providing a base material that, when heated to a particular manufacturing temperature, transforms into a finished material;
providing seeds that when heated transform into hollow spheres;
mixing said seeds with said base material to form a mixture of said seeds and said base material; and
heating said mixture to said manufacturing temperature to form a composite of said finished material with said hollow spheres embedded therein.

33. The method of claim 32, wherein said seeds each include:
a core having a particular composition that when heated reacts to form a gas; and
a coating around said core, said coating having a particular composition that when heated will fuse to form a continuous shell surrounding said core and trapping said gas generated by said core within said shell; and wherein
said trapped gas will produce a temperature dependent pressure within said shell;
said particular composition of said coating has a temperature dependent viscosity;
a first temperature corresponds to a working point of said particular composition of said coating;
a second temperature corresponds to a fluid point of said particular composition of said coating;
a third temperature corresponds to an equilibrium point where said pressure generated by said trapped gas within said shell is equal to a pressure outside of said shell; and
said particular composition of said core and said particular composition of said coating are selected so that said third temperature is greater than or equal to said first temperature, said third temperature is less than said second temperature, said manufacturing temperature is greater than or equal to said first temperature, and said manufacturing temperature is less than said second temperature.

34. The method of claim 32, wherein said article of manufacture is a masonry product.

35. The method of claim 32, wherein said article of manufacture is a brick.

36. The method of claim 32, wherein said article of manufacture is a ceramic.
